(19) United States
(12) Patent Application Publication
(10) Pub. No.: US 2022/0395132 A1
(43) Pub. Date: Dec. 15, 2022

(54) BEVERAGE MACHINE WITH INTERNAL AND EXTERNAL WATER RESERVOIRS

(71) Applicant: Keuring Green Mountain, Inc., Burlington, MA (US)

(72) Inventors: Devan Stacy, Arlington, MA (US); Benjamin Worth Coble, Winston-Salem, NC (US)

(73) Assignee: Keuring Green Mountain, Inc., Burlington, MA (US)

(21) Appl. No.: 17/640,464

(22) PCT Filed: Sep. 21, 2020
(86) PCT No.: PCT/US2020/051749

§ 371 Date: Mar. 4, 2022

Related U.S. Application Data
(60) Provisional application No. 62/904,782, filed on Sep. 24, 2019.

(51) Int. Cl. A47J 31/46; A47J 31/56

(52) U.S. Cl. CPC A47J 31/469; A47J 31/56; A47J 31/461

(57) ABSTRACT

A beverage machine having internal and external liquid reservoirs. Liquid can be selectively be provided from either the internal or external reservoir to a brew chamber to form a beverage. The internal reservoir may be provided with liquid only from a mains water connection, and the external reservoir may receive liquid by pouring into the reservoir. A valve may be coupled to the internal and external reservoirs and selectively fluidly connect either of the reservoirs to the brew chamber. The external reservoir may be removable from the machine housing, and the valve may fluidly connect the internal reservoir to the brew chamber when the external reservoir is removed.

### CROSS REFERENCE TO RELATED APPLICATION

This application claims the benefit of U.S. Provisional Application No. 62/904,782, filed Sep. 24, 2019, which is hereby incorporated by reference in its entirety.

### BACKGROUND

### 1. Field of Invention

This invention relates to beverage forming systems, such as coffee brewers that use a liquid to form a coffee beverage.

### 2. Related Art

Beverage forming systems that use a liquid, such as water, to form a beverage are well known. For example, U.S. Patent Application publication 2008/0134902 discloses a beverage forming system that heats water in a reservoir and pneumatically delivers the heated water to a brew chamber for making a coffee drink or other beverage. U.S. Pat. No. 7,398,726 discloses another beverage forming system that delivers heated water from a dispensing tank to a brew chamber by pneumatic forcing of the water from the metering tank. U.S. Patent Application publications 2009/0120299 and 2008/0092746, and U.S. Pat. Nos. 3,511,166, 3,958,502, 4,602,145, 4,263,498 and 8,037,811 disclose other system types in which water in a heater tank or heat exchanger is forced to flow out of the tank and to a beverage making station by introducing unheated water into the tank/exchanger.

### SUMMARY OF INVENTION

In one aspect of the invention, a beverage machine includes a liquid supply arranged to provide a liquid for forming a beverage. The liquid supply may include an external reservoir and an internal reservoir that may each hold water or other liquid to be supplied for making a beverage, e.g., by mixing water with beverage ingredients such as coffee grounds or a soluble drink material. A brew chamber may be arranged to hold a beverage material for mixing with the liquid to form a beverage, e.g., beverage material contained within a cartridge may be held by the brew chamber for mixing with liquid provided by the liquid supply to the brew chamber. A liquid conditioner may be arranged to heat and/or cool the liquid that is provided to the brew chamber, e.g., may include a heater tank or chiller to heat and/or cool water. A housing, e.g., including an internal frame or other structural component and/or external covering or skin, may be arranged to support at least portions of the liquid supply, brew chamber, liquid conditioner and/or other components, such as a user interface, control circuitry, etc. The internal reservoir may be located within the housing and the external reservoir may be located outside of the housing, e.g., so a user has access to the external reservoir so the user can provide water to the external reservoir. The liquid supply may be configured to selectively fluidly connect either the external reservoir to the brew chamber to provide liquid from the external reservoir to the brew chamber or the internal reservoir to the brew chamber to provide liquid from the internal reservoir to the brew chamber. Thus, the liquid supply may allow a controller of the beverage machine and/or a user to selectively use liquid from either the external reservoir or internal reservoir to form a beverage. Such an arrangement may, for example, make the beverage machine more easily configured to use either a mains water supply or other direct plumbed connection, or user-provided liquid to the external reservoir.

In some embodiments, the liquid supply may be configured to prevent delivery of liquid from the external reservoir to the internal reservoir, e.g., each reservoir may independently provide liquid for forming a beverage. In one embodiment, the liquid supply includes a valve that is fluidly coupled to the external reservoir and the internal reservoir, with the valve being configured to selectively couple the external reservoir to the brew chamber, or couple the internal reservoir to the brew chamber. For example, the liquid supply may include a valve that is fluidly coupled to the internal reservoir, and the external reservoir may be selectively couplable to the valve, e.g., by a user coupling the external reservoir to the beverage machine housing. The valve may be arranged to fluidly connect the internal reservoir to the brew chamber when the external reservoir is disconnected from the valve, and to fluidly connect the external reservoir to the brew chamber when the external reservoir is coupled to the valve.

In some embodiments, the liquid supply includes a pump and the liquid supply is arranged such that the pump pumps liquid either from the external reservoir to the brew chamber or from the internal reservoir to the brew chamber. In some cases, the liquid supply includes a mains water connection configured to connect to a mains water supply so the mains water connection provides water to the internal reservoir. The mains water connection may include a mains valve arranged to control flow of liquid from the mains water connection to the internal reservoir, and the internal reservoir may be vented to ambient pressure so as to hold liquid at ambient pressure. The mains water connection may include a liquid level sensor to detect a liquid level in the internal reservoir and the mains valve is controlled based on information from the liquid level sensor, e.g., the mains valve may be opened with the level in the internal reservoir is below a threshold and closed when the level is above the threshold.

In some embodiments, the external reservoir includes a tank base that is removably couplable to the housing, and the external reservoir may include a tank configured to hold liquid and be fluidly coupled to the tank base. The liquid supply may include a valve configured to fluidly couple to the tank base to fluidly connect the tank base and tank to the brew chamber. The liquid supply may include a pump fluidly coupled to the valve, and the pump may be configured to deliver liquid from the valve to the brew chamber. The valve may be configured to disconnect the internal reservoir from the pump when the tank base is coupled to the valve, e.g., so that water is provided only from the external reservoir to the pump.

In another aspect of the invention, a beverage machine includes a liquid supply arranged to provide a liquid for forming a beverage, with the liquid supply including an external reservoir and internal reservoir. A brew chamber may be arranged to hold a beverage material for mixing with the liquid to form a beverage, e.g., beverage material contained within a cartridge may be held by the brew chamber for mixing with liquid provided by the liquid supply to the brew chamber. A liquid conditioner may be arranged to heat and/or cool the liquid that is provided to the brew chamber, e.g., may include a heater tank or chiller to heat and/or cool water. A housing, e.g., including an internal frame or other structural component and/or external covering or skin, may be arranged to support at least portions of the liquid supply, brew chamber, liquid conditioner and/or other components, such as a user interface, control circuitry, etc. The internal reservoir may be located within the housing and the external reservoir may be located outside of the housing, e.g., so a user has access to the external reservoir so the user can provide water to the external reservoir. The liquid supply may be configured such that liquid is pourable into the external reservoir by a user and the internal reservoir is provided with liquid only via a mains water connection, e.g., a user may be prevented from providing liquid into the internal reservoir. In some cases, the liquid supply is configured to prevent fluid communication between the external reservoir and the internal reservoir, and thus the only way liquid can be provided to the internal reservoir is by a plumbed connection to the beverage machine.

In some embodiments, the liquid supply is configured to selectively fluidly connect either the external reservoir to the brew chamber to provide liquid from the external reservoir to the brew chamber or the internal reservoir to the brew chamber to provide liquid from the internal reservoir to the brew chamber. For example, the liquid supply may include a valve that is fluidly coupled to the external reservoir and the internal reservoir, and the valve may be configured to selectively couple the external reservoir to the brew chamber, or couple the internal reservoir to the brew chamber. The liquid supply may include a pump arranged such that the pump pumps liquid either from the external reservoir to the brew chamber or from the internal reservoir to the brew chamber.

The mains water connection may include a mains valve arranged to control flow of liquid from the mains water connection to the internal reservoir, and the internal reservoir may be vented to ambient pressure so as to hold liquid received from the mains water connection at ambient pressure. In some embodiments, the mains water connection includes a liquid level sensor to detect a liquid level in the internal reservoir and the mains valve is controlled based on information from the liquid level sensor.

The external reservoir may include a tank base that is removably couplable to the housing and a tank configured to hold liquid and be fluidly coupled to the tank base.

These and other aspects of the invention will be apparent from the following description and claims.

### BRIEF DESCRIPTION OF DRAWINGS

Aspects of the invention are described below with reference to the following drawings in which like numerals reference like elements, and wherein:

FIG. 1 is a left side perspective view of a beverage forming system in an illustrative embodiment;

FIG. 2 is a right side view of the beverage forming system in FIG. 1;

FIG. 3 shows a schematic diagram of functional components of the beverage forming system in an illustrative embodiment;

FIG. 4 shows a left side perspective view of the beverage forming system of FIG. 1 with the external reservoir removed from the housing;

FIG. 5 shows a perspective view of the external reservoir removed from the housing;

FIG. 6 shows a schematic view of an internal reservoir, mains water connection and control valve in an illustrative embodiment;

FIG. 7 shows a perspective view of an external tank base and control valve in an illustrative embodiment;

FIG. 8 shows a cross sectional view of the directional control valve when the external tank base is disconnected from the housing: and

FIG. 9 shows the cross sectional view of the control valve of FIG. 8 with the external tank base connected to the housing.

### DETAILED DESCRIPTION

It should be understood that aspects of the invention are described herein with reference to certain illustrative embodiments and the figures. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

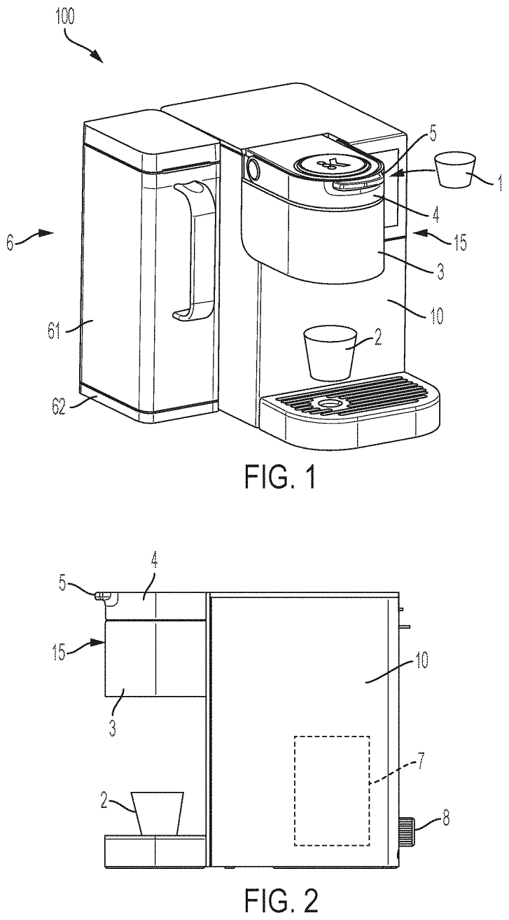

FIG. 1 shows a perspective view of a beverage forming system 100 that incorporates features of the invention. Although the beverage forming system 100 may be used to form any suitable beverage, such as tea, coffee, other infusion-type beverages, beverages formed from a liquid or powdered concentrate, soups, juices or other beverages made from dried materials, carbonated or uncarbonated beverages, or other, in this illustrative embodiment, the system 100 is arranged to form coffee or tea beverages. As is known in the art, a beverage cartridge 1 may be provided to the system 100 and used to form a beverage that is deposited into a user's cup or other suitable container 2. The cartridge 1 may be manually or automatically placed in a brew chamber 15 that includes a cartridge holder 3 and cover 4 of the beverage forming system 100. For example, the holder 3 may be or include a circular, cup-shaped or otherwise suitably shaped opening in which the cartridge 1 may be placed. With a cartridge 1 placed in the cartridge holder 3, a handle 5 may be moved by hand (e.g., downwardly) so as to move the cover 4 to a closed position (as shown in FIG. 1). In the closed position, the cover 4 at least partially covers the cartridge 1, which is at least partially enclosed in a space in which the cartridge is used to make a beverage. For example, with the cartridge 1 held by the cartridge holder 3 in the closed position, water or other liquid may be provided to the cartridge 1 (e.g., by injecting the liquid into the cartridge interior) to form a beverage that exits the cartridge 1 and is provided to a cup 2 or other container. Of course, aspects of the invention may be employed with any suitably arranged system 100, including drip-type coffee brewers, carbonated beverage machines, and other systems that deliver water to form a beverage. Thus, a cartridge 1 need not necessarily be used, but instead the brew chamber may accept loose coffee grounds or other beverage material to make a beverage. Also, the brew chamber 15 need not necessarily include a cartridge holder 3 and a cover 4. For example, the brew chamber may include a filter basket that is accessible to provide beverage material, and the filter basket itself may be movable, e.g., by sliding engagement with the beverage machine 10 housing, and a cover 4 may be fixed in place. In other embodiments, the brew chamber need not be user accessible, but instead beverage material may be automatically provided to, and removed from, the brew chamber. Accordingly, a wide variety of different types and configurations for a brew chamber may be employed with aspects of the invention.

In accordance with an aspect of the invention, liquid from either an external reservoir or an internal reservoir may be provided to a brew chamber to form a beverage. As discussed above, this may provide a beverage machine with options for supplying water or other liquid for use in forming a beverage. For example, as shown in FIG. 1, a user may pour or otherwise provide water to an external reservoir 6, which may then be delivered to the brew chamber 15 to form a beverage. Alternately, liquid may be provided from an internal reservoir 7 as shown in FIG. 2 to the brew chamber 15. The internal reservoir 7 may be provided with liquid from a mains water connection 8 which allows the machine 100 to be connected to a plumbed water source, such as a so-called city water or mains water supply. Such a supply is typically under pressure, and thus the mains water connection 8 may be configured to receive water at relatively high pressure, such as 60 psi or more. The internal reservoir 7 may be fluidly coupled to the mains water connection 8 so that water can be delivered to and stored by the internal reservoir 7 for delivery to the brew chamber 15. While in some embodiments the internal reservoir 7 may be provided with liquid by a user, e.g., by pouring the liquid through an opening in the beverage machine housing 10, in this embodiment the internal reservoir 7 can only be supplied with liquid from the mains water connection 8.

By arranging the beverage machine 100 with the ability to provide water from either an external reservoir 6 or an internal reservoir 7, a user may have different options for configuring the machine 100 in different environments. In some cases, a user may wish to use liquid in the external reservoir 6 for some beverages, and use liquid in the internal reservoir 7 for other beverages. City water in the internal reservoir 7 may be used for flavored beverages, while specially filtered or otherwise treated water in the external reservoir 6 may be used for other beverages, as merely one example. A user may manually operate a valve to switch between the reservoirs 6, 7, or may interact with another user interface component, such as a button or touch screen icon, that causes a controller to adjust the valve to supply liquid from a selected reservoir 6, 7. The machine 100 may allow a user to easily configure the machine 100 to use either predominately or only water from the external reservoir 6 or from the internal reservoir 7. As an example, a user may not have a mains water supply available for the machine 100, and so may use only the external reservoir 6 for liquid supply. In this case, the machine 100 may be set to use only liquid from the external reservoir 6. In other situations, the user may wish to use only water from a mains water supply, and thus the machine 100 may be set to use water from the internal reservoir 7 only. As discussed more below, where liquid from an external reservoir 6 is not used, the user may remove the external reservoir 6 from the housing 10, e.g., to reduce a size of the machine 100. The liquid supply of the machine 100 may be adapted to automatically connect and/or disconnect the internal reservoir 7 with respect to the brew chamber 15 based on whether the external reservoir 6 is connected to the machine 100. Thus, connection of the external reservoir 6 to the machine 100 may disconnect the internal reservoir 7 from the brew chamber, and vice versa, i.e., the internal reservoir 7 may be automatically connected to the brew chamber 15 with the external reservoir 6 disconnected from the machine 100.

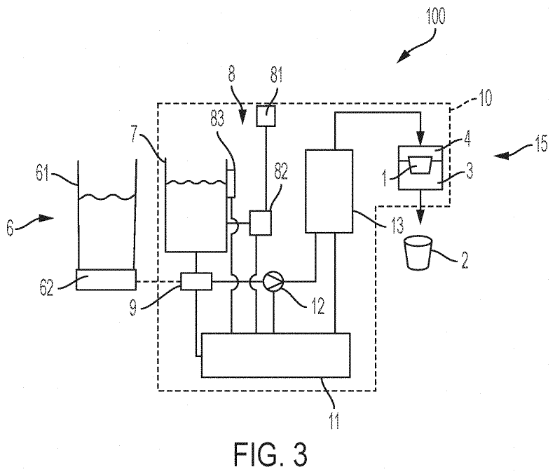

FIG. 3 shows a schematic diagram of a liquid supply and other components of a beverage machine 100 for handling liquid used to make a beverage. The liquid supply of the machine 100 in this embodiment includes an external reservoir 6 and an internal reservoir 7 for providing liquid to form a beverage at the brew chamber 15. Various components of the machine 100 such as the internal reservoir 7, control valve 9, pump 12, liquid conditioner 13, etc. may be within or part of the machine housing 10, while the external reservoir 6 is located outside of the housing 10. Both the external reservoir 6 and the internal reservoir 7 may be fluidly connected to a control valve 9 which can selectively couple either of the reservoirs 6, 7 to the brew chamber 15 for delivery of liquid. This may allow the machine 100 to use liquid from either reservoir 6, 7 depending on a user's desire, a type of beverage to be made, or other criteria. The control valve 9 may be controllable, such as manually by a user or electronically by a controller 11, to select between the external reservoir 6 and internal reservoir 7. For example, the control valve 9 may have a knob, button, slider or other user actuable element on the housing 10 that can be pressed, turned or otherwise actuated to select between the reservoirs 6, 7, i.e., to select which reservoir 6, 7 will provide liquid to form a beverage. Where the valve 9 is electrically actuable, the user actuable element may include an electronic switch or other user interface component that provides information to the controller 11, which may control the valve 9 accordingly. Alternately, the controller 11 may automatically control the valve 9 based on other information, such as beverage formation parameters defined by a type of beverage to be made. Beverage parameters may be set by default by the controller 11, by a user interacting with a user interface, and/or by reading a machine readable feature on a cartridge 1 and using corresponding parameters.

In some embodiments, the external reservoir 6 may be removable from the housing 10, e.g., to allow a user to more easily provide liquid to the external reservoir 6 and/or to allow the machine 100 to operate using only the internal reservoir 7 to supply liquid. For example, a user may connect a mains water supply to the mains water connection 8 with the intention of never using the external reservoir 6 to provide liquid for beverage formation. In such a case, the external reservoir 6 may be removed, e.g., to reduce the footprint or other size of the machine 100 on a countertop or other location. The control valve 9 may be arranged to allow the external reservoir 6 to be removed from the housing 10, thereby disconnecting the external reservoir 6 from the brew chamber 15. In some embodiments, the control valve 9 may be arranged to automatically fluidly connect the internal reservoir 7 to the brew chamber 15 when the external reservoir 6 is removed from the housing 10. That is, although the valve 9 may permit selection between reservoirs 6, 7 when the external reservoir 6 is attached to the housing 10, when the external reservoir 6 is disconnected, the valve 9 may automatically fluidly connect the internal reservoir 7 to the brew chamber 15. This may avoid any need for a user to adjust the valve 9 to select the internal reservoir 7 when the external reservoir 6 is removed. As discussed in more detail below, the valve 9 may be arranged to automatically connect the external reservoir 6 to the brew chamber 15 when the external reservoir 6 is connected to the housing 10 or valve 9, and automatically connect the internal reservoir 7 to the brew chamber 15 when the external reservoir 6 is disconnected from the housing 10 or valve 9.

In the embodiment of FIGS. 1 and 3, the external reservoir 6 includes a tank 61 and a tank base 62. The tank base 62 may be connectable to the housing 10 and/or valve 9, and provide a fluid coupling between the tank 61 and the tank base 62. This may allow a user to remove the tank 61 from the tank base 62, e.g., for easier filling of the tank 61, while the tank base 62 remains coupled to the housing 10 and/or valve 9. An outlet of the tank 61 may have a valve that closes when the tank 61 is removed from the tank base 62, e.g., to prevent leaking, and that opens when the tank 61 is placed on the tank base 62 and the outlet of the tank 61 is coupled to an inlet of the tank base 62. Such removable tanks are known in the art. The machine 100 may include a sensor (not shown) to detect the presence of the tank 61, e.g., to control operation of the machine 100 and/or the valve 9. For example, if the tank 61 is removed while the tank base 62 remains coupled to the valve 9 and/or housing 10, the controller 11 may prevent machine operation to form a beverage. Alternately, the controller 11 may control the valve 9 to select the internal reservoir 7 when the tank 61 is removed.

In this embodiment, the control valve 9 and/or other portions of the liquid supply (such as one or more check valves) are arranged such that liquid cannot be transferred from the external reservoir 6 to the internal reservoir 7, or from the internal reservoir 7 to the external reservoir 6. While the external reservoir 6 may receive liquid poured by a user into the reservoir 6, the internal reservoir 7 in this embodiment receives liquid only from the mains water connection 8. Thus, in this embodiment a user cannot pour or otherwise provide liquid to the internal reservoir 7 other than via the mains water connection 8, although in other embodiments the internal reservoir 7 may be arranged to receive liquid poured by a user into the reservoir 7. In this arrangement, the mains water connection 8 includes a connector 81 configured to fluidly connect to a hose, pipe, tube, fitting or other component that provides mains water to the connector 81. The mains water connection 8 also includes a mains valve 82 that controls flow of mains water to the internal reservoir 7 and a level sensor 83 to detect a liquid level in the internal reservoir 7. The mains valve 82 can be controlled by the controller 11 based on information from the liquid level sensor 83, e.g., the mains valve 82 can be opened to allow flow until the level in the internal reservoir 7 reaches a particular level, at which point the mains valve 82 is closed to flow. In this embodiment, the internal reservoir 7 is vented to hold liquid at ambient pressure. This can allow the internal reservoir 7 to be made less robustly since the reservoir 7 need not be arranged to withstand the pressure of the mains water supply.

Liquid at the control valve 9, whether supplied by the external or internal reservoir 6, 7, may be provided to the brew chamber 15 in different ways, as discussed more below. In this embodiment, the liquid supply of the machine 100 includes a pump 12 which pumps liquid from the valve 9 to the brew chamber 15. Employing a pump 12 may allow the machine 100 to vary a flow rate and/or pressure of the liquid as desired, e.g., to form espresso-type or other beverages using higher pressure liquid as well as drip-type coffee or other beverages made using lower pressure liquid. This embodiment also includes a liquid conditioner 13, such as an inline heating element, heater tank, chiller tank and associated refrigeration system, etc. that can heat and/or cool and/or carbonate and/or otherwise condition liquid for use in forming a beverage. The conditioned liquid is delivered to the brew chamber 15 for mixing with a beverage medium (or not) and for dispensing as a beverage.

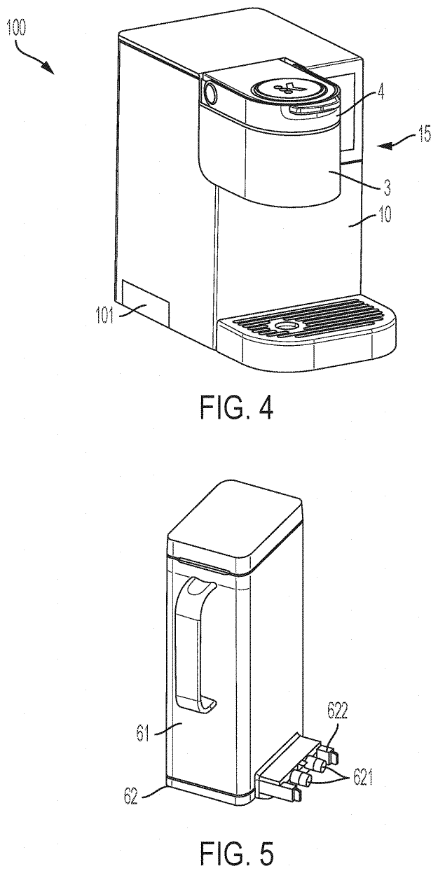

As described above, the external reservoir 6 may be removable from the housing 10, as shown in FIG. 4. This may reduce the size of the machine 100, freeing counter space or other areas around the machine 100. The housing 10 may have a port 101 or other opening to mechanically and fluidly couple to the external reservoir 6, and the port 101 may be covered by a door or other element when the external reservoir 6 is removed. FIG. 5 shows the external reservoir 6 removed from the housing 10 and illustrates mechanical and fluid connection elements exposed on the tank base 62. The tank base 62 includes a pair of fluid ports 621 that provide a fluid connection between the tank 61 and the control valve 9, and mechanical connectors 622 that physically connect the tank base 62 and tank 61 to the housing 10. Two fluid ports 621 are provided in this embodiment, one for a liquid supply to the brew chamber 15 and another to a manometer or other fluid level indicator or sensor regarding a liquid level in the tank 61. Of course, only one port 621 could be provided if desired (although in some cases, withdrawal of liquid from a single port 621, e.g., by the pump 12, may draw water away from a manometer or other liquid level sensor, causing a false level reading, at least temporarily). The fluid ports 621 may be valved so that the ports 621 close when the tank base 62 is disconnected from the housing 10. This may help prevent significant leaking of liquid from the ports 621, e.g., if there is water in the tank 61 at the time of disconnection. The mechanical connectors 622 may engage with corresponding elements of the housing 10 in any suitable way, such as by a bayonet connection, tongue-and-groove connection, mortise and tenon connection, etc. One or more fasteners, such as screws or rivets, may secure the tank base 62 to the housing 10 if desired.

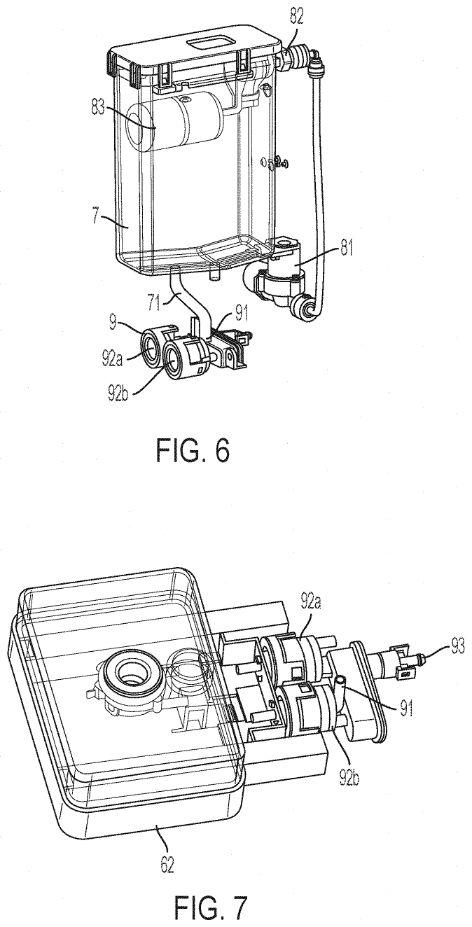

FIG. 6 shows the internal reservoir 7, mains water connection 8 and control valve 9 in an illustrative embodiment. The mains water connector 81 may include a pressure reducing valve or regulator, e.g., to lower a pressure of water entering at the connector 81. In this embodiment, the mains valve 82 is a float-operated valve, i.e., the liquid level sensor 83 in this embodiment is a float that is movable based on a liquid level in the internal reservoir 7. When the liquid level is below a threshold, the mains valve 82 is open to admit water into the reservoir 7, and when the liquid level is at or above the threshold, the mains valve 82 is closed by the float element 83. As noted above, the internal reservoir 7 is vented so that liquid in the reservoir 7 is held at ambient pressure. An outlet of the internal reservoir 7 is coupled via an outlet line 71 to a first inlet 91 of the control valve 9. The fluid ports 621 of the tank base 62 are connectable to second inlets 92 of the control valve 9, as shown in FIG. 7. One of the second inlets, i.e., second inlet 92a, provides a fluid connection between the external reservoir 6 and a manometer or other liquid level sensor or indicator. The other of the second inlets, i.e., second inlet 92b, provides a fluid connection between the external reservoir 6 and the brew chamber 15. The control valve 9 in this embodiment is arranged so that in the condition shown in FIG. 6 with the tank base 62 disconnected from the valve 9, the valve 9 fluidly connects the outlet line 71 of the internal reservoir 7 and the first inlet 91 to the valve outlet 93, which is coupled to the brew chamber 15. However, with the tank base 62 connected to the valve 9 as shown in FIG. 7, the fluid connection between the first inlet 91 and the valve outlet 93 is closed, and the second inlet 92b is fluidly coupled to the valve outlet 93.

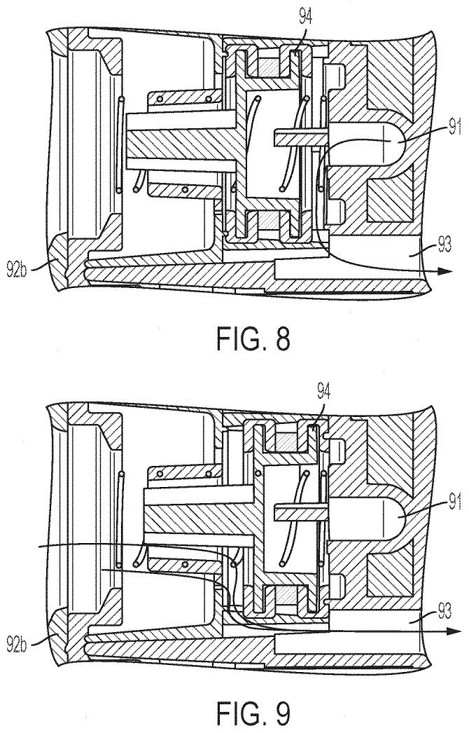

FIG. 8 shows a cross sectional view of the second inlet 92b of the valve 9 in the condition shown in FIG. 6 where the external reservoir 6 is disconnected from the valve 9 and/or housing 10. In this embodiment, a valve element 94 is spring biased to move to the left in FIG. 8 so as to open a fluid connection between the first inlet 91 (and the internal reservoir 7) and the valve outlet 93, i.e., so that the internal reservoir 7 is fluidly coupled to the brew chamber 15. This is the normal state of the valve 9 when the tank base 62 is not connected to the valve 9 and/or housing 10. However, when the tank base 62 is coupled to the valve 9 as shown in FIG. 9, the valve element 94 is moved to the right against the spring bias. This closes the fluid connection between the first inlet 91 and the valve outlet 93, and opens fluid communication between the second inlet 92b and the valve outlet 93 which had previously been closed in the state of FIG. 8. This fluidly couples the external reservoir 6 with the brew chamber 15.

It should be appreciated that the beverage machine 100 may include different components than those shown in FIG. 3 and/or may operate in different ways. The pump 12 may be any suitable type of pump, such as a centrifugal pump, piston pump, solenoid pump, diaphragm pump, etc. Although not shown, a check valve or other flow controller (such as an electronically-controlled valve) can be used to prevent backflow or other flow in a conduit between the pump 12 and the liquid conditioner 13, and/or the liquid conditioner 13 and the brew chamber 15. A pressure relief valve may be used to vent any suitable section of the liquid conduit between the reservoirs 6, 7 and the brew chamber 15, e.g., in the case of pressure over a threshold level. In some embodiments, the pump 12 may pump air through the liquid conduit, e.g., to purge the liquid conduit, liquid conditioner 13 and/or brew chamber 15. In such a case, a valve may be provided to permit air flow to the pump 12, e.g., the control valve 9 may have an air inlet to selectively connect the inlet of the pump 12 to an air supply.

Operation of the pump 12 and other components of the machine 100 may be controlled by the control circuit 11, which may include a programmed processor and/or other data processing device along with suitable software or other operating instructions, one or more memories (including non-transient storage media that may store software and/or other operating instructions), temperature and liquid level sensors, pressure sensors, input/output interfaces (such as a user interface on the housing 10), communication buses or other links, a display, switches, relays, triacs, or other components necessary to perform desired input/output or other functions. A user interface may be arranged in any suitable way and include any suitable components to provide information to a user and/or receive information from a user, such as buttons, a touch screen, a voice command module (including a microphone to receive audio information from a user and suitable software to interpret the audio information as a voice command), a visual display, one or more indicator lights, a speaker, and so on.

The liquid conditioner 13 and/or the brew chamber 15 may be provided with a desired amount of liquid by any suitable technique, such as running the pump 12 for a predetermined time, detecting a flow rate or volume of liquid passing through the pump (e.g., using a flow meter), operating the pump 12 for a desired number of cycles (such as where the pump is arranged to deliver a known volume of liquid for each cycle, such as for each revolution of a pump shaft), or using any other viable technique. Alternately, the liquid conditioner, such as a heater tank may be determined to be completely or otherwise suitably filled when a pressure sensor (not shown) detects a rise in pressure indicating that the water has reached the top of the heater tank, when a conductive probe detects the presence of liquid in an upper portion of the tank, when an optical sensor detects a presence of liquid in the tank, and others.

Liquid may be introduced into the cartridge 1 or brew chamber 15 at any suitable pressure, e.g., 1-2 psi or higher, and the pressure may be adjustable by the control circuit 11. The brew chamber 15 may include any beverage making ingredient or material, such as ground coffee, tea, a flavored drink mix, or other beverage medium, e.g., contained in a cartridge 1 or not. Alternately, the brew chamber 15 may function simply as an outlet for heated water, e.g., where a beverage medium is contained in a user's cup 2. Once liquid delivery by the pump 12 is complete, an air pump may be operated to force air into the brew chamber 15 and/or other portions of the liquid conduit to help remove liquid.

While in this illustrative embodiment, a liquid supply system arranged to provide liquid to a beverage outlet (at the brew chamber 15) may include a pump 12, other arrangements may be used. Alternately, other mechanisms for providing liquid may be used, such as by gravity flow of liquid, flow forced by air pressure, or other motive force to move liquid from a reservoir 6, 7, such as pressure from a mains water supply, and others.

For those systems employing a cartridge 1, once a cartridge is located in the brew chamber 15 in the closed position, the beverage forming system 100 may use the cartridge 1 to form a beverage. For example, one or more inlet needles associated with the cover 4 or other part of the system 100 may pierce the cartridge 1 (e.g., a lid of the cartridge) so as to inject heated water or other liquid into the cartridge 1. The injected liquid may form the desired beverage or a beverage precursor by mixing with beverage material in the cartridge 1. The cover 4, cartridge holder 3 or other portion of the system 100 may also include one or more outlet needles or other elements to puncture or pierce the cartridge 1 at an outlet side to permit the formed beverage to exit the cartridge 1. Other inlet/outlet piercing arrangements are possible, such as multiple needles, a shower head, a non-hollow needle, a cone, a pyramid, a knife, a blade, etc. In another arrangement, a beverage machine may include a piercing element (such as a spike) that forms an opening and thereafter a second inlet element (such as a tube) may pass through the formed hole to introduce liquid into (or conduct liquid out of) the container. In other embodiments, a lid or other portion of a cartridge may be pierced, or otherwise effectively opened for flow, by introducing pressure at an exterior of the lid. For example, a water inlet may be pressed and sealed to the lid exterior and water pressure introduced at the site. The water pressure may cause the lid to be pierced or otherwise opened to allow flow into the cartridge 1. In another arrangement, the cartridge lid may include a valve, conduit or other structure that opens when exposed to a suitable pressure and/or when mated with a water inlet tube or other structure. As with the inlet piercing arrangement, the outlet piercing arrangement may be varied in any suitable way. Thus, the outlet piercing element may include one or more hollow or solid needles, knives, blades, tubes, and so on. Alternately, the cartridge 1 may include a valve, septum or other element that opens to permit beverage to exit when liquid is introduced into the cartridge, but otherwise remains closed (e.g., to protect the beverage medium from external conditions such as oxygen, moisture or others). In such a case, no piercing element for forming the outlet opening is necessarily required although may be used, e.g., to allow the valve or other element to open. Also, in this illustrative embodiment the piercing element remains in place to receive beverage as it exits the opening formed in the cartridge. However, in other embodiments, the piercing element may withdraw after forming an opening, allowing beverage to exit the opening and be received without the piercing element being extended into the cartridge 1. Other arrangements for a beverage outlet are possible however, e.g., the cartridge may have a permeable portion that allows beverage to exit cartridge 1. Also, there is no requirement that an inlet and/or an outlet pierce a cartridge to provide liquid to, or receive beverage from, a cartridge. Instead, communication with a cartridge may be performed using any suitable ports or other features.

With a beverage cartridge 1 provided in the brew chamber 15 or beverage material (if used) otherwise provided with the brew chamber 15, the control circuit 11 may operate in different ways to dispense a beverage. In some embodiments, the control circuit 11 may automatically select one or more brew parameters for automatically controlling the liquid supply and liquid conditioner portions to dispense a beverage during a dispensing operation. For example, the control circuit 11 may select default values for parameters such as a which reservoir 6, 7 will supply liquid to form the beverage, a beverage volume, beverage temperature, whether beverage frothing or whipping will be employed, a beverage dispense time or speed, a precursor liquid flow rate, a precursor liquid pressure, whether beverage chilling will be employed, whether brew chamber air or steam purge will be employed, whether beverage material pre-wet or pulse-type brewing will be employed and if so time periods between liquid delivery, and others. Such parameters may be automatically determined in different ways, such as by reading parameter values from an information element (such as an RFID tag) on a cartridge 1, receiving input from a user via a user interface such as by the user pressing a button or otherwise indicating a parameter, by employing default values stored in a memory of the control circuit 11, and/or by a combination of such techniques or others. In some cases, the control circuit 11 may begin a dispensing operation once the brew parameter values are set, or in response to additional user input such as the user pressing a brew start button. In one example, a user may press one of several beverage volume buttons to select a beverage volume, and then press a brew start button to cause the control circuit 11 to start an automated dispensing operation. Parameters used to dispense a beverage may be set by default by the control circuit 11 and/or by input from the user. For example, other brew parameters such as beverage temperature, etc. may be automatically selected by the control circuit 11 using default values unless the user provides additional input to adjust those values.

The control circuit 11 may execute an automated dispensing operation (in this example in response to depression of the start button) in different ways since dispensing processes may include different steps which may be performed in series and/or in parallel. For example, in some embodiments a heater tank may store a volume of pre-heated water such that the control circuit 11 may immediately control the pump 12 to deliver additional water to the tank, thereby causing the flow of heated water from the heater tank to the brew chamber 15 at the start of a dispensing operation. In other embodiments, water in the heater tank may first need to be heated, and thus the control circuit 11 may first cause a heating element to heat water in the heater tank, and then automatically start water delivery once heating is complete. Of course, other beverage machine 100 configurations may involve other steps at part of an automated dispensing operation. For example, if the beverage machine 100 employs an inline or flow through heater as a heater tank, the control circuit 11 may cause a heating element of the inline heater to begin heating and then simultaneously or shortly thereafter begin causing water flow through the inline heater and to the brew chamber. Where no pump is used by the beverage machine 100, water flow may be caused by gravity, steam pressure in an inline heater, or other.

With water or other liquid sufficiently heated in the heater tank, the control circuit 11 may continue with the automated process of beverage dispensing by causing the pump 12 to deliver liquid to the tank, thereby delivering heated liquid to the brew chamber 15. The control circuit 11 may sense or otherwise keep track of a volume of liquid delivered to the brew chamber 15 so that the appropriate beverage volume can be dispensed. For example, the control circuit 11 may cause the pump 12 to operate a specified number of cycles where a particular volume of liquid is delivered by the pump 12 for each pump cycle. Alternately, a flow meter may be used by the control circuit 11 to detect a volume of liquid delivered to the brew chamber 15, or other techniques.

While aspects of the invention may be used with any suitable cartridge, or no cartridge at all, some cartridges may include features that enhance the operation of a beverage forming system 100. As is known in the art, the cartridge 1 may take any suitable form such as those commonly known as a sachet, pod, capsule, container or other. For example, the cartridge 1 may include an impermeable outer covering within which is housed a beverage medium, such as roasted and ground coffee or other. The cartridge 1 may also include a filter so that a beverage formed by interaction of the liquid with the beverage medium passes through the filter before being dispensed into a container 2. As will be understood by those of skill in the art, cartridges in the form of a pod having opposed layers of permeable filter paper encapsulating a beverage material may use the outer portion of the cartridge 1 to filter the beverage formed. The cartridge 1 in this example may be used in a beverage machine to form any suitable beverage such as tea, coffee, other infusion-type beverages, beverages formed from a liquid or powdered concentrate, etc. Thus, the cartridge 1 may contain any suitable beverage material, e.g., ground coffee, tea leaves, dry herbal tea, powdered beverage concentrate, dried fruit extract or powder, powdered or liquid concentrated bouillon or other soup, powdered or liquid medicinal materials (such as powdered vitamins, drugs or other pharmaceuticals, nutriaceuticals, etc.), and/or other beverage-making material (such as powdered milk or other creamers, sweeteners, thickeners, flavorings, and so on). In one illustrative embodiment, the cartridge 1 contains a beverage material that is configured for use with a machine that forms coffee and/or tea beverages, however, aspects of the invention are not limited in this respect.

As used herein, “beverage” refers to a liquid substance intended for drinking that is formed when a liquid interacts with a beverage material, or a liquid that is dispensed without interacting with a beverage material. Thus, beverage refers to a liquid that is ready for consumption, e.g., is dispensed into a cup and ready for drinking, as well as a liquid that will undergo other processes or treatments, such as filtering or the addition of flavorings, creamer, sweeteners, another beverage, etc., before being consumed.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A beverage machine comprising:
a liquid supply arranged to provide a liquid for forming a beverage, the liquid supply including an external reservoir and an internal reservoir;
a brew chamber arranged to hold a beverage material for mixing with the liquid to form a beverage;
a liquid conditioner arranged to heat or cool the liquid that is provided to the brew chamber; and
a housing arranged to support at least portions of the liquid supply, brew chamber and liquid conditioner, the internal reservoir being located within the housing and the external reservoir being located outside of the housing,
wherein the liquid supply is configured to selectively fluidly connect either the external reservoir to the brew chamber to provide liquid from the external reservoir to the brew chamber or the internal reservoir to the brew chamber to provide liquid from the internal reservoir to the brew chamber.

2. The machine of claim 1, wherein the liquid supply is configured to prevent delivery of liquid from the external reservoir to the internal reservoir.

3. The machine of claim 1, wherein the liquid supply includes a valve that is fluidly coupled to the external reservoir and the internal reservoir, the valve being configured to selectively couple the external reservoir to the brew chamber, or couple the internal reservoir to the brew chamber.

4. The machine of claim 1, wherein the liquid supply includes a valve that is fluidly coupled to the internal reservoir, and wherein the external reservoir is selectively couplable to the valve, the valve being arranged to fluidly connect the internal reservoir to the brew chamber when the external reservoir is disconnected from the valve, and to fluidly connect the external reservoir to the brew chamber when the external reservoir is coupled to the valve.

5. The machine of claim 1, wherein the liquid supply includes a pump and the liquid supply is arranged such that the pump pumps liquid either from the external reservoir to the brew chamber or from the internal reservoir to the brew chamber.

6. The machine of claim 1, wherein the liquid supply includes a mains water connection configured to connect to a mains water supply, the mains water connection being fluidly coupled to the internal reservoir.

7. The machine of claim 6, wherein the internal reservoir is vented to ambient pressure so as to hold liquid at ambient pressure.

8. The machine of claim 6, wherein the mains water connection includes a mains valve arranged to control flow of liquid from the mains water connection to the internal reservoir.

9. The machine of claim 8, wherein the mains water connection includes a liquid level sensor to detect a liquid level in the internal reservoir and the mains valve is controlled based on information from the liquid level sensor.

10. The machine of claim 1, wherein the external reservoir includes a tank base that is removably couplable to the housing.

11. The machine of claim 10, wherein the external reservoir includes a tank configured to hold liquid and be fluidly coupled to the tank base.

12. The machine of claim 11, wherein the liquid supply includes a valve configured to fluidly couple to the tank base to fluidly connect the tank base and tank to the brew chamber.

13. The machine of claim 12, wherein the liquid supply includes a pump fluidly coupled to the valve, the pump configured to deliver liquid from the valve to the brew chamber.

14. The machine of claim 13, wherein the valve is configured to disconnect the internal reservoir from the pump when the tank base is coupled to the valve.

15. The machine of claim 1, wherein the external reservoir is selectively connectable to and removable from the housing.

16. The machine of claim 15, wherein the liquid supply include a valve that is configured to fluidly couple to the external reservoir to the brew chamber and to disconnect the internal reservoir from the pump when the external reservoir is connected to the housing.

17. The machine of claim 16, wherein the valve is configured to fluidly couple the internal reservoir to the brew chamber when the external reservoir is disconnected from the housing.

18. A beverage machine comprising:
a liquid supply arranged to provide a liquid for forming a beverage, the liquid supply including an external reservoir and internal reservoir;
a brew chamber arranged to hold a beverage material for mixing with the liquid to form a beverage;
a liquid conditioner arranged to heat or cool the liquid that is provided to the brew chamber; and
a housing arranged to support at least portions of the liquid supply, brew chamber, and liquid conditioner, the internal reservoir being located within the housing, and the external reservoir being located outside of the housing,
wherein the liquid supply is configured such that liquid is pourable into the external reservoir by a user and the internal reservoir is provided with liquid only via a mains water connection.

19. The machine of claim 18, wherein the liquid supply is configured to prevent fluid communication between the external reservoir and the internal reservoir.

20. The machine of claim 18, wherein the liquid supply is configured to selectively fluidly connect either the external reservoir to the brew chamber to provide liquid from the external reservoir to the brew chamber or the internal reservoir to the brew chamber to provide liquid from the internal reservoir to the brew chamber.

21-29. (canceled)
